(19) United States
(12) Patent Application Publication
(10) Pub. No.: US 2020/0247126 A1
(43) Pub. Date: Aug. 6, 2020

(54) LIQUID DISCHARGE APPARATUS

(71) Applicant: Atsushi Kikuchi, Kanagawa (JP)

(72) Inventor: Atsushi Kikuchi, Kanagawa (JP)

(73) Assignee: Ricoh Company, Ltd., Tokyo (JP)

(21) Appl. No.: 16/712,705

(22) Filed: Dec. 12, 2019

(30) Foreign Application Priority Data
Jan. 31, 2019 (JP) 2019-016242

(51) Int. Cl. B41J 2/165

(52) U.S. Cl. CPC B41J 2/16535; B41J 2002/16558; B41J 2/16523; B41J 2/16552

(57) ABSTRACT

A liquid discharge apparatus includes a plurality of heads and a wiper. Each of the heads includes a nozzle face having a plurality of nozzles configured to discharge a liquid. The wiper includes a wiping member configured to clean, by wiping, the nozzle face of each of the plurality of heads. The apparatus further includes circuitry configured to control cleaning of the plurality of heads by the wiper, cause the wiper to perform a first wiping operation on a part of the plurality of heads, and cause the wiper to perform a second wiping operation, different from the first wiping operation, on a rest of the plurality of heads.

### CROSS-REFERENCE TO RELATED APPLICATION

This patent application is based on and claims priority pursuant to 35 U.S.C. § 119(a) to Japanese Patent Application No. 2019-016242, filed on Jan. 31, 2019, in the Japan Patent Office, the entire disclosure of which is hereby incorporated by reference herein.

### BACKGROUND

### Technical Field

The present disclosure relates to a liquid discharge apparatus.

### Description of the Related Art

An apparatus including a head that discharges a liquid (a liquid discharge head) includes a wiper that wipes, for example, a nozzle face of the head in order to maintain and recover the state of the head.

There are inkjet printers that have first and second cleaning modes to clean a head, and wiping conditions such as the pressing force and the wiping speed can be made different between the first cleaning mode and the second cleaning mode. For example, the first cleaning mode is to suck a head by a suction unit and then wipe the head by a wiper, and the second cleaning mode is for during printing, in which the head is wiped by the wiper without being sucked by the suction unit.

### SUMMARY

According to an embodiment of this disclosure, a liquid discharge apparatus includes a plurality of heads and a wiper. Each of the heads includes a nozzle face having a plurality of nozzles configured to discharge a liquid. The wiper includes a wiping member configured to clean, by wiping, the nozzle face of each of the plurality of heads. The apparatus further includes circuitry configured to control cleaning of the plurality of heads by the wiper, cause the wiper to perform a first wiping operation on a part of the plurality of heads, and cause the wiper to perform a second wiping operation, different from the first wiping operation, on a rest of the plurality of heads.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of a printer that is a liquid discharge apparatus according to a first embodiment of the present disclosure;

FIG. 2 is a plan view of an example of a liquid discharge unit of the printer illustrated in FIG. 1;

FIG. 3 is a plan view illustrating an example of a maintenance and recovery mechanism (a maintenance unit) for the liquid discharge unit illustrated in FIG. 2;

FIG. 4 is a plan view illustrating a state in which the maintenance unit is moved in a wiping direction;

FIG. 5 is a front view of the maintenance unit;

FIG. 6 is a side view illustrating an example of a wiping mechanism of the maintenance unit illustrated in FIG. 3;

FIG. 7 is a plan view of the wiping mechanism illustrated in FIG. 6;

FIG. 8 is a block diagram illustrating a configuration relating to control of a wiping operation by the wiping mechanism illustrated in FIGS. 6 and 7;

FIG. 9 is a flowchart illustrating a maintenance operation according to one embodiment, including the wiping operation (nozzle face cleaning) controlled by a wiping controller illustrated in FIG. 8;

FIG. 10A is a flowchart of a first wiping operation performed by the wiping mechanism in the nozzle face cleaning;

FIG. 10B is a flowchart of a second wiping operation performed by the wiping mechanism in the nozzle face cleaning;

FIG. 11A is a front view illustrating the maintenance unit illustrated in FIG. 5, performing an example of the first wiping operation;

FIG. 11B is a front view illustrating the maintenance unit illustrated in FIG. 5, performing an example of the second wiping operation;

FIG. 12 is a plan view illustrating an example of an update process of a target head of the first wiping operation;

FIG. 13 is a plan view illustrating a state in the update process, subsequent to the state illustrated in FIG. 12;

FIG. 14 is a diagram illustrating, in front views, a transition of state of the nozzle face of one head in the nozzle face cleaning according to one embodiment;

FIG. 15 is a flowchart illustrating a normal cleaning in the nozzle face cleaning illustrated in FIG. 9;

FIG. 16A is flowchart of a suction operation in the normal cleaning illustrated in FIG. 15;

FIG. 16B is flowchart of a web wiping operation in the normal cleaning illustrated in FIG. 15;

FIG. 16C is flowchart of a wiper wiping operation in the normal cleaning illustrated in FIG. 15;

FIG. 17 is a front view of the maintenance unit illustrated in FIG. 5, performing the suction operation;

FIG. 18 is a front view of the maintenance unit illustrated in FIG. 5, performing the web wiping operation;

FIG. 19 is a front view of the maintenance unit illustrated in FIG. 5, performing the wiper wiping operation;

FIGS. 20A and 20B are respectively front views of the maintenance unit performing the first wiping operation and the second wiping operation according to a second embodiment;

FIG. 21 is a front view illustrating a maintenance unit according to a third embodiment;

FIG. 22 is a flowchart illustrating a maintenance operation according to the third embodiment, including the wiping operation controlled by the wiping controller;

FIG. 23 is a flowchart illustrating a maintenance operation according to a fourth embodiment, including the wiping operation controlled by the wiping controller;

FIG. 24 is a flowchart illustrating a maintenance operation according to a fifth embodiment, including the wiping operation controlled by the wiping controller; and

FIG. 25 is a flowchart illustrating the wiping operation in FIG. 24.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views thereof, embodiments of this disclosure are described. As used herein, the singular forms “a”, “an”, and “the” are intended to include the plural forms as well, unless the context clearly indicates otherwise.

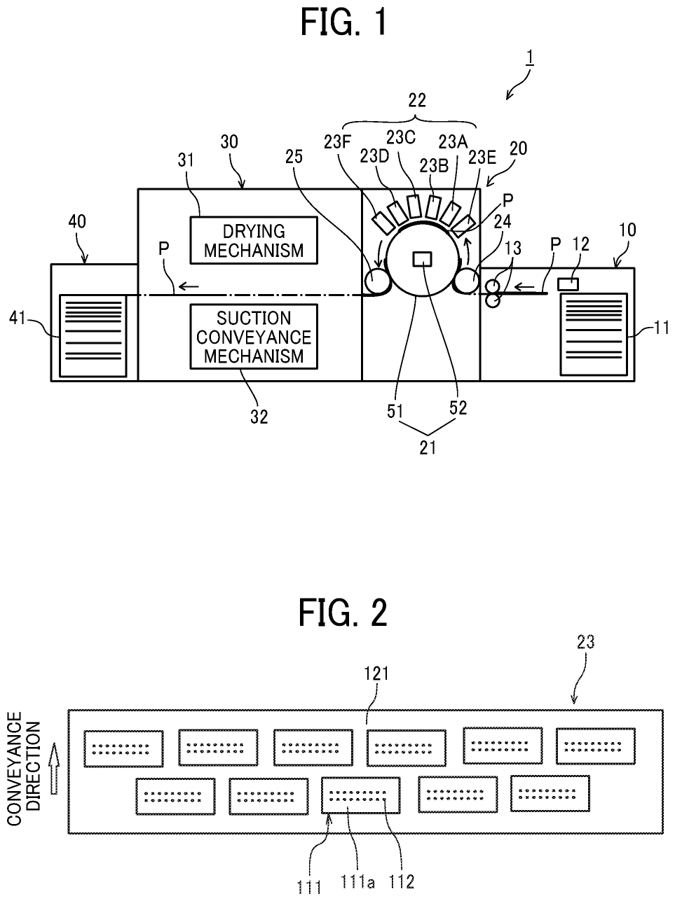

A liquid discharge apparatus according to a first embodiment of the present disclosure is described with reference to FIGS. 1 and 2. FIG. 1 is a schematic view of a printer as the liquid discharge apparatus according to the first embodiment. FIG. 2 is a plan view of an example of a liquid discharge unit of the printer illustrated in FIG. 1.

A printer 1 includes a carrying-in unit 10, a printer unit 20, a drying unit 30, and an unloading unit 40. In the printer 1, the printer unit 20 applies liquid to a sheet P carried from the carrying-in unit 10, thereby performing printing, and the drying unit 30 dries the liquid adhering to the sheet P, after which the sheet P is ejected to the unloading unit 40.

The carrying-in unit 10 includes a carrying-in tray 11 on which a plurality of sheets P are stacked, a feeder 12 that separates and sends the sheets P one by one from the carrying-in tray 11, and a registration roller pair 13 that feeds the sheets P to the printer unit 20.

The feeder 12 can be any feeding device such as a device using a roller or a roll, or a device using air suction. After the leading end of the sheet P sent out from the carrying-in tray 11 by the feeder 12 reaches the registration roller pair 13, the registration roller pair 13 is driven at a predetermined timing, to send the sheet P to the printer unit 20.

The printer unit 20 includes a sheet conveyor 21 that conveys the sheet P. The sheet conveyor 21 includes a drum 51 and a suction device 52. The drum 51 bears the sheet P on a peripheral surface thereof and rotates. The suction device 52 generates a suction force on the peripheral surface of the drum 51.

The printer unit 20 includes a liquid discharge device 22 that discharges a liquid toward the sheet P carried on the drum 51 of the sheet conveyor 21.

The printer unit 20 includes a transfer cylinder 24 that receives the sheet P and forwards the sheet P to the drum 51 and a transfer cylinder 25 that forwards the sheet P conveyed by the drum 51 to the drying unit 30.

The transfer cylinder 24 includes a sheet gripper to grip the leading end of the sheet P conveyed from the carrying-in unit 10 to the printer unit 20. The sheet thus gripped is conveyed as the transfer cylinder 24 rotates. The transfer cylinder 24 forwards the sheet P to the drum 51 at a position opposite the drum 51.

Similarly, the drum 51 includes a sheet gripper on the surface thereof, and the leading end of the sheet P is gripped by the sheet gripper. The drum 51 includes a plurality of suction holes dispersed on the surface thereof. The suction device 52 generates suction airflows orienting inward from the suction holes of the drum 51.

On the drum 51, the sheet gripper grips the leading end of the sheet P forwarded from the transfer cylinder 24, and the sheet P is attracted to and carried on the drum 51 by the suction airflows by the suction device 52. As the drum 51 rotates, the sheet P is conveyed.

The liquid discharge device 22 includes discharge units 23 (23A to 23F) that discharge liquids. For example, the discharge unit 23A discharges a cyan (C) liquid, the discharge unit 23B discharges a magenta (M) liquid, the discharge unit 23C discharges a yellow (Y) liquid, and the discharge unit 23D discharges a black (K) liquid.

In addition, the discharge unit 23E is disposed upstream from the discharge unit 23A in the direction of rotation of the drum 51 (a sheet conveyance direction), and the discharge unit 23F is disposed downstream from the discharge unit 23D. Each the discharge units 23E and 23F are used to discharge one of yellow, magenta, cyan, and black liquids or a special liquid of, for example, white or gold (or silver). Furthermore, a discharge unit that discharges a treatment liquid such as a surface coating liquid may be provided.

The discharge unit 23 is a full line head and includes a plurality of liquid discharge heads 111 (hereinafter simply referred to as “heads 111”) arranged on a base 121. For example, nozzle rows including a plurality of nozzles 112 are arranged on a nozzle face 111a as illustrated in FIG. 2.

The discharge operation of each discharge unit 23 of the liquid discharge device 22 is controlled by a drive signal corresponding to print data. When the sheet P carried on the drum 51 passes through a region facing the liquid discharge device 22, the respective color liquids are discharged from the discharge units 23, and an image corresponding to the print data is formed.

The drying unit 30 includes a drying mechanism 31 to dry the liquid applied on the sheet P in the printer unit 20 and a suction conveyance mechanism 32 to convey the sheet P conveyed from the printer unit 20 while sucking the sheet P (suction conveyance).

The sheet P conveyed from the printer unit 20 is received by the suction conveyance mechanism 32, conveyed passing through the drying mechanism 31, and forwarded to the unloading unit 40.

When the sheet P passes through the drying mechanism 31, the liquid on the sheet P is dried. As a result, a liquid component such as moisture in the liquid evaporates, and the colorant contained in the liquid is fixed on the sheet P. Additionally, curling of the sheet P is inhibited.

The unloading unit 40 includes an unloading tray 41 on which a plurality of sheets P are stacked. The sheets P conveyed from the drying unit 30 are sequentially stacked and held on the unloading tray 41.

The printer 1 can further include, for example, a pretreatment unit disposed upstream from the printer unit 20, or a post-processing unit (a finisher) disposed between the drying unit 30 and the unloading unit 40. The pretreatment unit performs pretreatment on the sheet P. The post-processing unit performs post-processing of the sheet P to which the liquid is applied.

For example, the pretreatment unit coats the sheet P with a treatment liquid that reacts with the liquid to inhibit bleeding (a pre-coating process). For example, the post-processing unit turns upside down the sheet printed by the printer unit 20 and again sends the sheet to the printer unit 20 for performing printing on both sides of the sheet (a sheet reversal conveyance process). Alternatively, the post-processing unit can bind together a plurality of sheets.

Although the printer to perform printing on cut sheets P is described as the liquid discharge apparatus, aspects of this disclosure are applicable to a printer or the like to perform printing on a continuous medium, such as continuous paper.

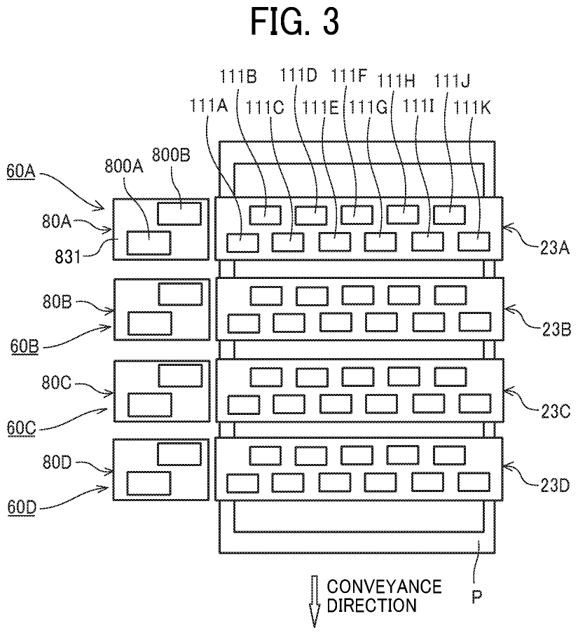

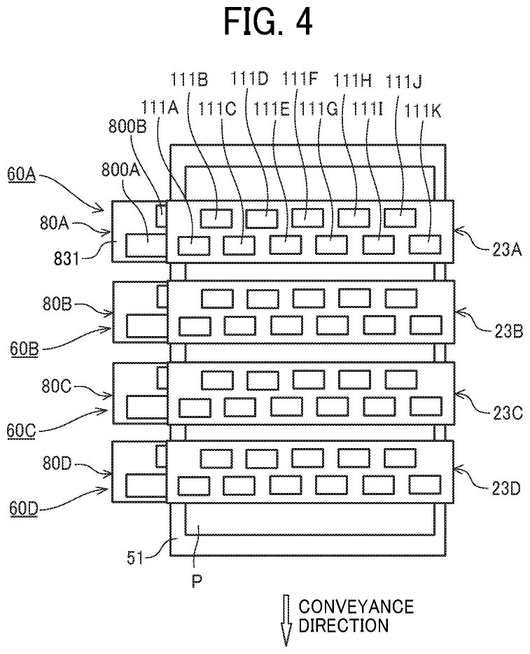

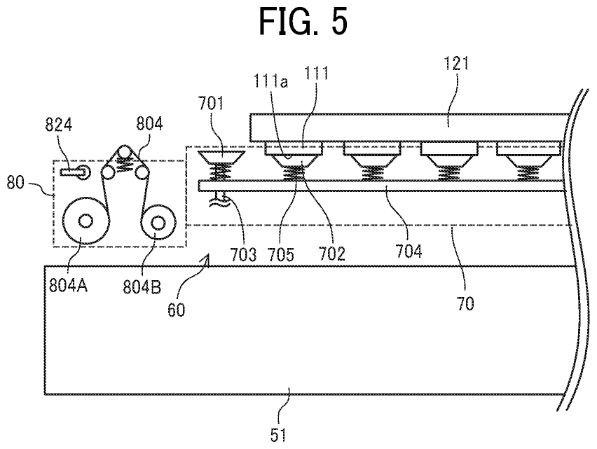

Next, a description is given of an example of a maintenance and recovery mechanism (a maintenance unit) of the printer according to the present embodiment, with reference to FIGS. 3 to 5. FIG. 3 is a plan view illustrating the maintenance unit. FIG. 4 is a plan view illustrating a state in which the maintenance unit is moved in a wiping direction. FIG. 5 is a front view of the maintenance unit. In order to simplify the drawings, only the discharge units 23A to 23D are illustrated in FIGS. 3 and 4.

Each of the discharge units 23 includes a plurality of heads 111 (111A to 111K) arranged in a staggered manner. However, the structure of the discharge unit 23 is not limited thereto.

Corresponding to the discharge units 23 (23A to 23D), maintenance units 60 (60A to 60D) are disposed. The maintenance unit 60 includes a cap unit 70 (see FIG. 5) for capping the nozzle face 111a of the head 111, and a wiping mechanism 80 (80A to 80D) as a wiper to wipe the nozzle face 111a of the head 111.

The cap unit 70 includes one suction cap 701 and moisturizing caps 702. The suction cap 701 caps and sucks the nozzle face 111a of the head 111. The number of the moisturizing caps 702 corresponds to the number of heads 111, and each moisturizing cap 702 caps the nozzle face 111a of the head 111 and retains moisture thereon. A suction device such as a suction pump or the like is coupled to the suction cap 701 via a tube 703.

The suction cap 701 and the plurality of moisturizing caps 702 are held movably up and down by a cap holder 704. Compression coil springs 705 are respectively interposed between the suction cap 701 and the plurality of moisturizing caps 702 and the cap holder 704. The compression coil springs 705 press the suction cap 701 and moisturizing caps 702 against the nozzle faces 111a.

The wiping mechanism 80 includes two wiping units 800 (800A and 800B) disposed on a rail 831 and at a distance from each other in a head arrangement direction corresponding to the rows of the heads 111. Alternatively, the wiping mechanism 80 can be configured to wipe the plural rows of heads 111 with one wiping unit 800.

As illustrated in FIG. 4, the wiping unit 800 wipes the nozzle face 111a as the rail 831 moves in the head arrangement direction (direction orthogonal to the conveyance direction).

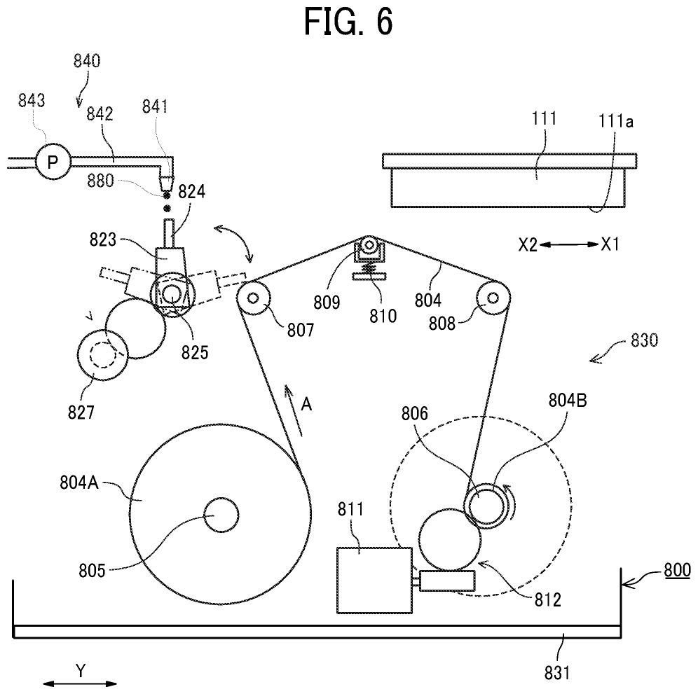

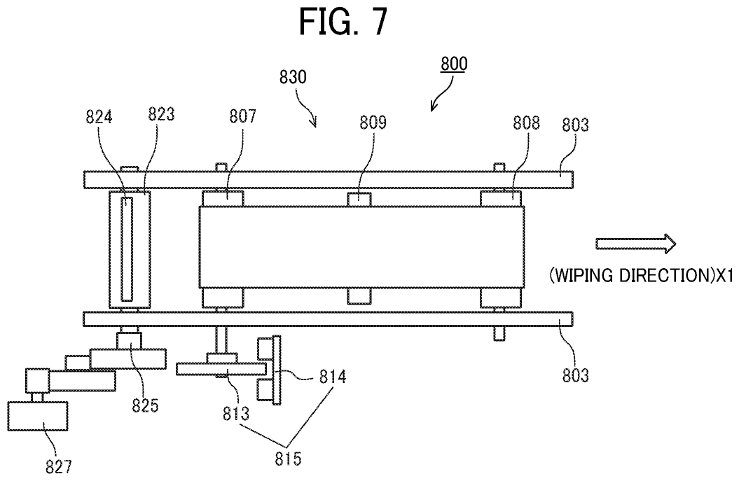

Next, an example of the wiping mechanism is described with reference also to FIGS. 6 and 7. FIG. 6 is a side view of the wiping mechanism, and FIG. 7 is a plan view of the wiping mechanism.

In the wiping unit 800 of the wiping mechanism 80, side plates 803 hold a feed roller 805 and a winding roller 806. The feed roller 805 serves as a shaft of a feeding roll 804A around which a web 804 is wound. The web 804 is a first wiping member. The winding roller 806 serves as a shaft of a winding roll 804B to wind the web 804 fed from the feeding roll 804A. The web 804 is fed in the direction indicated by arrow A.

The side plates 803 further support guide rollers 807 and 808 rotatably. A pressing member 809 disposed between the guide rollers 807 and 808 presses the web 804 against the nozzle face 111a to be wiped. When the wiping operation is performed, the pressing member 809 presses the web 804 against the nozzle face 111a with a pressing force exerted by a spring 810. The strength of the pressing force can be stored in a memory, for example, by a manufacturer based on empirical data.

Preferably, the web 804 is a sheet-like material that has absorbency and liquid resistance, at least, against the liquid used and does not cause fuzz and dust. Examples of such materials include, but are not limited to, nonwoven fabric, cloth, film, and paper.

To the winding roller 806, a driving force is transmitted from a winding motor 811 via a transmission assembly 812 including a gear train.

A code wheel 813 is mounted on the guide roller 807, and an encoder sensor 814 is provided to the code wheel 813. The encoder sensor 814 includes a transmissive photosensor that detects a pattern formed on the code wheel 813. The code wheel 813 and the encoder sensor 814 together serve as an encoder 815 that detects the distance of movement (feed amount) of the web 804.

Further, as a second wiping member, a wiper 824 that is a shaped like a blade or a plate is disposed upstream from the web 804 in a first wiping direction (arrow X1 direction). The wiper 824 is held by a wiper holder 823. The wiper holder 823 is held rotatably (to be able to displace) on the side plates 803 by a shaft 825.

Referring to FIG. 6, as the wiper holder 823 rotates, the wiper 824 is rotated (displaced) between a first position (home position) indicated by the solid line, a second position indicated by the phantom line, and a third position indicated by the broken line.

At the first position, the wiper 824 wipes the nozzle face 111a. The wiper 824 retreats to the second position when wiping is performed with only the web 804. At the third position, the wiper 824 is pressed against the web 804.

The web 804, the feed roller 805, the winding roller 806, the guide rollers 807 and 808, the pressing member 809, the wiper 824, and the like held by the side plates 803 are assembled into a wiping cartridge 830 and can be detachably mounted on the rail 831.

The wiping unit 800 can reciprocate in the arrow X direction, which is the nozzle array direction of the head 111. The reciprocating movement of the wiping unit 800 is enabled by, for example, a moving mechanism to move the rail 831. Such moving mechanism can include a timing belt and a pulley.

Further, the apparatus main body includes a cleaning liquid application device 840 to drip a cleaning liquid 880 thereby applying the cleaning liquid 880 onto the wiper 824. The cleaning liquid application device 840 includes a cleaning liquid supply tube 842 having a nozzle 841 to drip (or discharge) the cleaning liquid 880, a cleaning liquid pump 843 to supply the cleaning liquid 880 to the nozzle 841 through the cleaning liquid supply tube 842, and the like.

When applying the cleaning liquid 880 to the web 804, the cleaning liquid application device 840 applies the cleaning liquid 880 to the wiper 824, rotates the wiper 824 to the position indicated by the broken line to be pressed against the web 804, and transfers the cleaning liquid 880 to the web 804. However, the cleaning liquid 880 can be directly applied to the web 804.

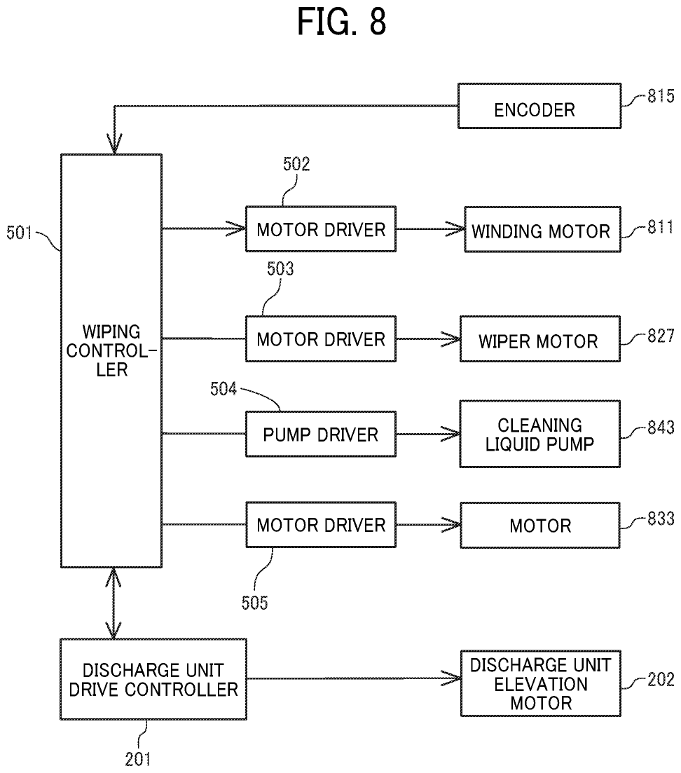

Next, a description is given of a structure relating to control of the wiping operation by the wiping unit with reference to the block diagram of FIG. 8.

A wiping controller 501 controls the operation relating to the wiping unit 800, and can be configured as a portion of a controller of the printer 1, for example. Such a controller can have a configuration similar to a general-purpose computer and includes, for example, a central processing unit (CPU), memories such as a read only memory (ROM) and a random access memory (RAM), and the like.

The wiping controller 501 controls driving of the winding motor 811 that drives the winding roller 806 via a motor driver 502. In this case, the wiping controller 501 counts the output pulses of the encoder 815, detects the winding amount of the web 804, and controls driving of the winding motor 811.

The wiping controller 501 controls driving of a wiper motor 827 via a motor driver 503 and rotates the wiper holder 823, thereby rotating the wiper 824 to the first position and the second position. A stepping motor is used as the wiper motor 827, and the rotation amount of the wiper 824 is controlled by the number of pulses.

The wiping controller 501 controls driving of the cleaning liquid pump 843 via a pump driver 504, thereby controlling application (supply) of the cleaning liquid 880 to the wiper 824.

The wiping controller 501 controls a motor 833 via a motor driver 505, thereby controlling the movement of the wiping unit 800 in the wiping direction relative to the nozzle face 111a.

The wiping controller 501 controls, via a discharge unit drive controller 201, a discharge unit elevation motor 202 that lifts and lowers the discharge unit 23, thereby controlling the contact of the nozzle faces 111a with the web 804 of the wiping unit 800. The discharge unit drive controller 201 can be configured as a portion of a controller of the printer 1

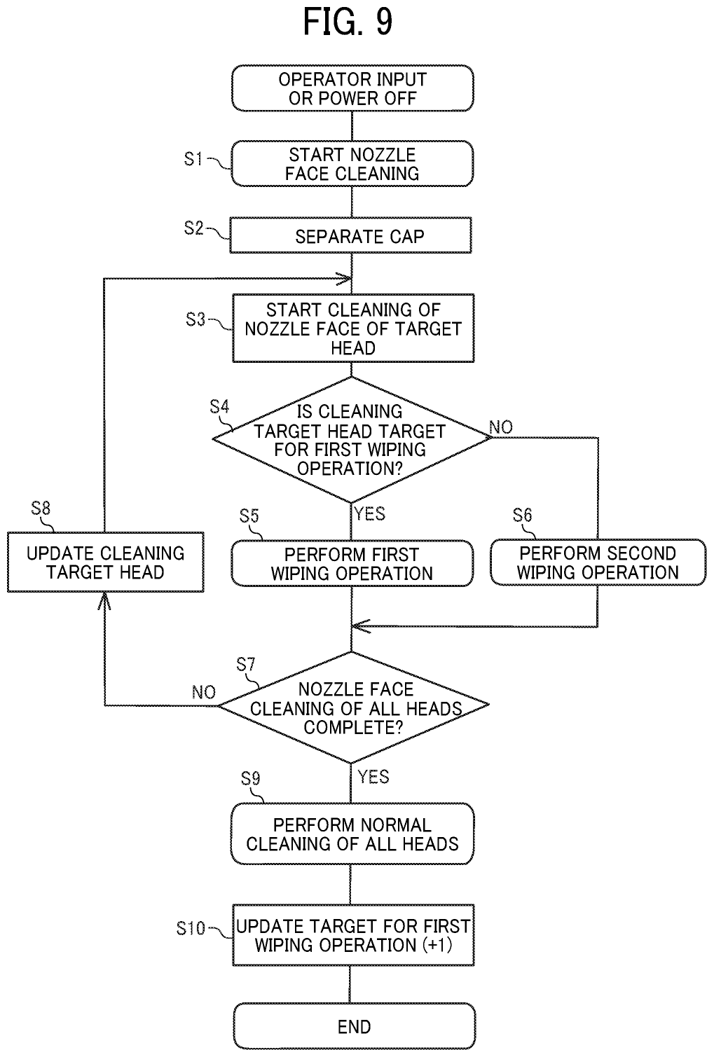

Next, a description is given of the maintenance operation including the control of the wiping operation by the wiping controller, with reference to the flowchart of FIG. 9.

In the present embodiment, execution of nozzle face cleaning is scheduled in response to an input by an operator at the end of printing for that day or automatically executed in response to power off. The nozzle face cleaning is a part of the maintenance operation to wipe and clean the nozzle faces 111a of the heads 111 with the web 804 (step S1, hereinafter simply referred to as “S1”).

The wiping controller 501 raises the discharge unit 23 via the discharge unit drive controller 201 and separates the caps 701 and 702 of the cap unit 70 (S2) from the nozzle faces 111a (decaps the nozzle faces 111a).

Thereafter, the wiping controller 501 moves the wiping unit 800 to the wiping start position of the head 111 (a cleaning target head) to be cleaned (to be wiped) and starts cleaning of the nozzle face 111a (S3). When the wiping unit 800 moves, the entire maintenance unit 60 moves.

Here, the wiping controller 501 determines whether or not the cleaning target head 111 is a target of the first wiping operation (S4).

At this time, when the cleaning target head 111 is the target of the first wiping operation, the wiping controller 501 performs the first wiping operation to wipe and clean the nozzle face 111a (S5). By contrast, when the cleaning target head 111 is not the target of the first wiping operation, the wiping controller 501 performs a second wiping operation, different from the first wiping operation, to wipe and clean the nozzle face 111a (S6).

The cleaning power of the first wiping operation higher, and the cleaning power of the second wiping operation is lower. Here, the term “cleaning power” represents the ability to remove deposits adhering to the nozzle face. The surface cleaning power can be increased by increasing the pressure to press the web 804 or the number of times of wiping with the web 804. When the cleaning power is high, the damage to the nozzle face 111a is large.

Thereafter, the wiping controller 501 determines whether or not the cleaning (nozzle face cleaning) by wiping of the nozzle faces 111a of all the heads 111 has been completed (S7). In response to a determination that the nozzle face cleaning of all the heads 111 is not yet completed, the wiping controller 501 updates the cleaning target head 111 (S8), and repeats the operations from S4 to S7.

In response to a determination that the nozzle face cleaning of all the heads 111 is completed, the wiping controller 501 performs normal cleaning of all the heads 111 (S9).

Note that, during execution of the nozzle face cleaning, the nozzles 112 are exposed (in a decap state), and the liquid in the nozzles 112 thickens with elapse of time. Accordingly, the normal cleaning is performed for all the heads 111 to prevent the occurrence of discharge defect due to the thickening.

That is, during the execution of the nozzle face cleaning, the nozzle faces 111a are released from the suction cap 701 and the moisturizing caps 702, and the nozzle faces 111a are exposed to air for a longer time. In particular, in the head 111 the nozzle face 111a of which is cleaned first, the nozzles 112 are exposed to air until the nozzle face cleaning of the remaining heads 111 is completed. Thus, the liquid in the nozzles 112 may dry and solidify.

Since the liquid is not properly discharged in this state, normal cleaning for nozzle recovery is performed in the present embodiment. Therefore, execution of the normal cleaning can be obviated in a configuration in which thickening in the nozzles is unlikely to occur during the nozzle face cleaning. Such a case is, for example, when the duration of the nozzle face cleaning is short, or a liquid difficult to dry is used.

Then, the wiping controller 501 updates (+1) the head 111 that is the target of the first wiping operation (S10). With this operation, in the next nozzle face cleaning, the first wiping operation is performed on the updated head 111, and the second wiping operation is performed on the other heads 111.

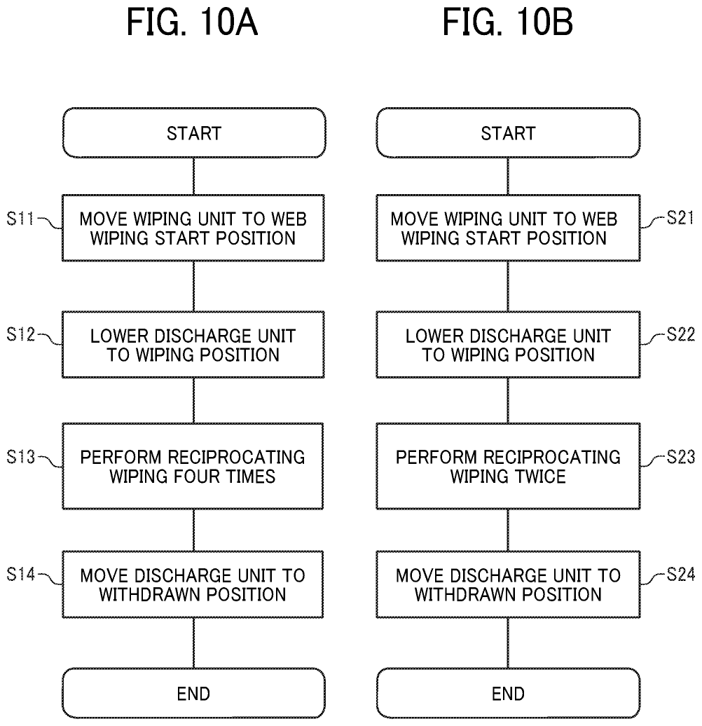

Next, a description is given of the first wiping operation and the second wiping operation, with reference to FIGS. 10A and 10B. FIG. 10A is a flowchart of the first wiping operation, and FIG. 10B is a flowchart of the second wiping operation.

Referring to FIG. 10A, in the first wiping operation, the wiping controller 501 moves the wiping unit 800 to the wiping start position by the web 804 (S11), and lowers the discharge unit 23 to the wiping position (S12).

Then, the wiping controller 501 causes the wiping unit 800 to reciprocate four times in the directions indicated by arrows X1 and X2 in FIG. 6 and causes the web 804 to wipe the nozzle face 111a (S13).

Thereafter, the wiping controller 501 raises the discharge unit 23 to the withdrawn position via the discharge unit drive controller 201 (S14).

Referring to FIG. 10B, in the second wiping operation, the wiping controller 501 moves the wiping unit 800 to the wiping start position by the web 804 (S12), and lowers the discharge unit 23 to the wiping position (S22).

Then, the wiping controller 501 causes the wiping unit 800 to reciprocate twice in the directions indicated by arrows X1 and X2 in FIG. 6 and causes the web 804 to wipe the nozzle face 111a (S23).

Thereafter, the wiping controller 501 raises the discharge unit 23 to the withdrawn position via the discharge unit drive controller 201 (S24).

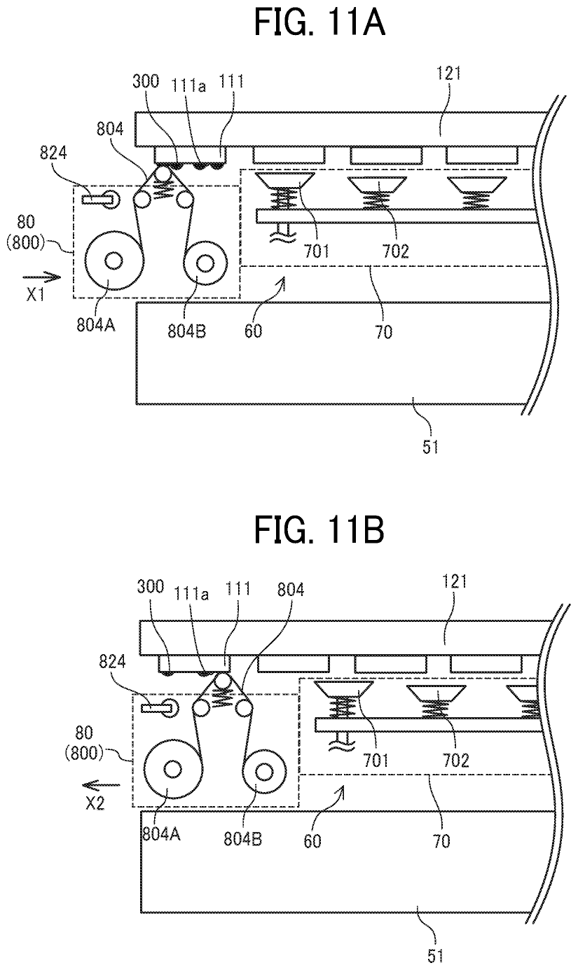

Next, a description is given of examples of the first wiping operation and the second wiping operation, with reference to FIGS. 11A and 11B, which are front views of the maintenance unit 60.

As illustrated in FIG. 11A, the wiping unit 800 (the maintenance unit 60) moves to the wiping start position of the cleaning target head, which is, for example, the head 111A (see FIGS. 3 and 4). Then, the discharge unit 23 descends to the wiping position, and the web 804 contacts the nozzle face 111a of the head 111A.

In this state, the wiping unit 800 moves in the direction indicated by arrow X1 to the wiping end position as illustrated in FIG. 11B, and the web 804 wipes the nozzle face 111a of the head 111. Thereafter, the wiping unit 800 moves in the direction indicated by arrow X2, returns to the wiping start position, and again wipes the nozzle face 111a of the head 111 with the web 804.

In this way, the nozzle face 111a is wiped by the reciprocation of the wiping unit 800, and deposits 300 on the nozzle face 111a are removed. The deposits 300 include mist, a thickened product thereof, a solidified product, and the like.

The number of reciprocations of the wiping unit 800 is four in the first wiping operation and two in the second wiping operation.

As the number of times of wiping by the wiping unit 800 increases, a greater amount of deposits 300 can be removed from the nozzle face 111a, but the duration of wiping (time required for cleaning) increases. By contrast, as the number of times of wiping by the wiping unit 800 decreases, the duration of wiping decreases, but the deposits 300 tend to remain on the nozzle face 111a.

Therefore, in the first wiping operation, the number of times of wiping is set to the number by which the deposits 300 adhering to and solidified on the nozzle face 111a can be fully removed. By contrast, in the second wiping operation, the number of times of wiping is such a number that the deposits 300 are removed to the extent to prevent discharge defect, even though all the deposits 300 on the nozzle face 111a are not removed. The number of times of wiping can be set according to conditions such as the type of liquid used, the head, and the web. Further, the wiping method is not limited to reciprocating wiping, but can be repeated wiping in one direction.

The first wiping operation with a greater number of times of wiping is performed on a part of the heads 111 of the plurality of heads 111, to remove deposits, and the second wiping operation with a smaller number of times of wiping is performed on the rest of the heads 111. Thus, the wiping time is shortened while securing cleanliness.

Accordingly, the maintenance of the plurality of heads by the wiping operation can be efficiently performed.

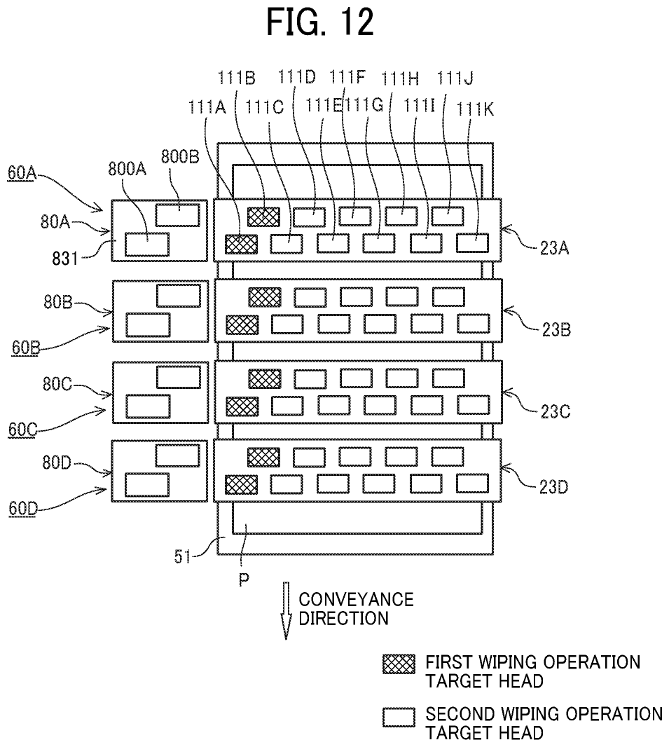

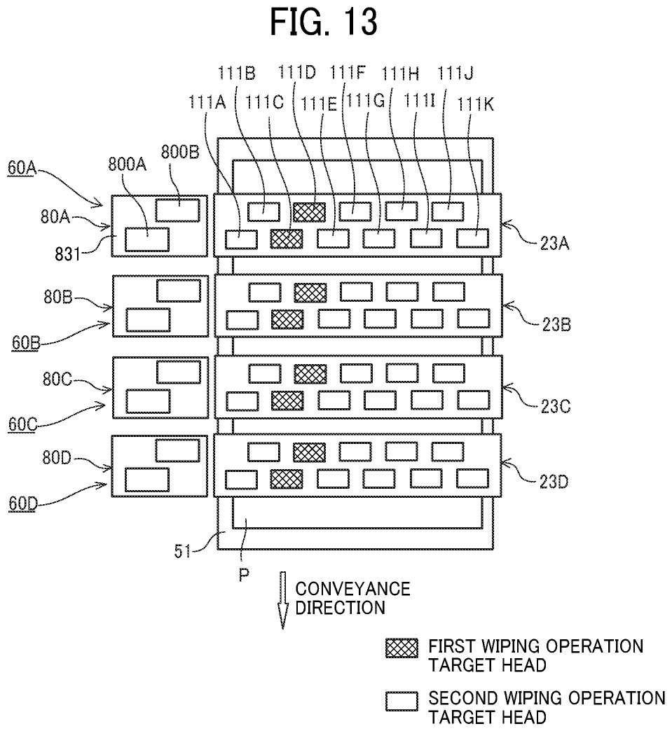

Next, a description is given of an example of the update process of the head that is the target of the first wiping operation, with reference to FIGS. 12 and 13. FIGS. 12 and 13 are plan views illustrating the update process of the head.

In the nozzle face cleaning, as described above, all the heads 111 are cleaned by either the first wiping operation or the second wiping operation, and the target head of the first wiping operation is updated (changed) in S10 illustrated in FIG. 9 each time the nozzle face cleaning is executed.

For example, in the first round of the nozzle face cleaning, as illustrated in FIG. 12, the respective heads 111A and 111B of the discharge units 23 are set as the target heads of the first wiping operation, and the other heads 111C to 111K are cleaned by the second wiping operation. As the first round of the nozzle face cleaning is executed, the heads 111C and 111D are set as the target heads of the next first wiping operation in the update process.

Accordingly, in the second round of the nozzle face cleaning, as illustrated in FIG. 13, the respective heads 111C and 111D of the discharge units 23 are set as the target heads of the first wiping operation, and the other heads 111A, 111B, and 111E to 111K are cleaned by the second wiping operation. As the second round of the nozzle face cleaning is performed, the heads 111E and 111F are set as the target heads of the next first wiping operation in the update process.

Hereinafter, the same process is performed in the third and subsequent rounds of the nozzle face cleaning.

For example, when the printer 1 is set to execute the nozzle face cleaning after printing of the day ends, the target heads of the first wiping operation are changed day. In the case where the number of the heads 111 is 11 as in the present embodiment, each head 111 is cleaned by the first wiping operation once 6 days.

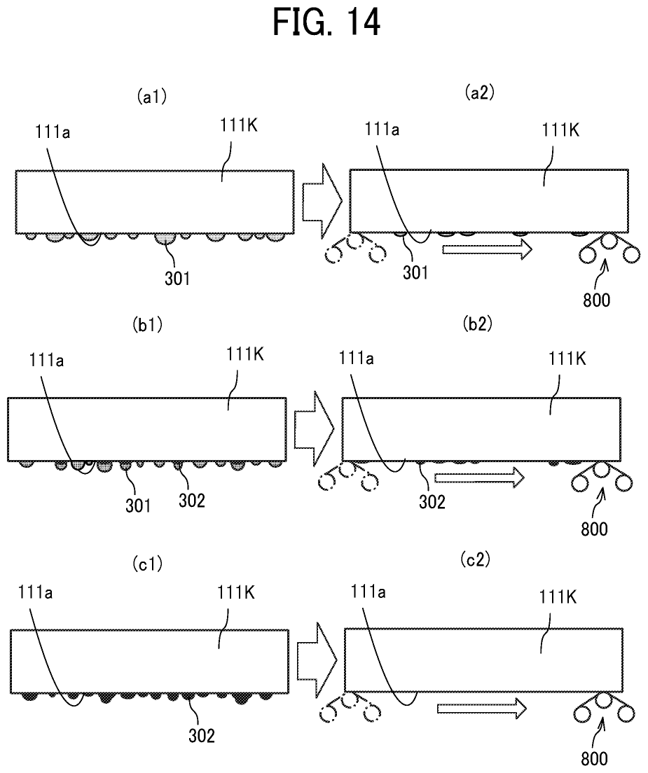

The effect of performing such a nozzle face cleaning is described with reference to FIG. 14. FIG. 14 is a diagram illustrating, in front views, a transition of state of the nozzle face of one head in the nozzle face cleaning.

For example, when the printing operation for one day is completed, as illustrated in the state (a1) in FIG. 14, a liquid 301 such as mist (in the form of particles) are on the nozzle face 111a of the head 111K.

Therefore, the second wiping operation is performed in the first round of the nozzle face cleaning to remove the liquid 301 and clean the nozzle face 111a. However, the liquid 301 are not fully removed as illustrated in the state (a2) in FIG. 14, and a portion of the liquid 301 remains on the nozzle face 111a.

Therefore, as illustrated in the state (b1) in FIG. 14, the liquid 301 remaining on the nozzle face 111a of the head 111K dries and thickens to become, for example, a solidified product 302. Further, the liquid 301 newly adheres to the nozzle face 111a by the printing of next day.

Then, the second wiping operation is performed in the second round of the nozzle face cleaning, to remove the liquid 301 and the solidified product 302 and clean the nozzle face 111a. However, portions of the liquid 301 and the solidified product 302 remain on the nozzle face 111a as in the state (a2) of FIG. 14.

The adhesion of the liquid 301 and the remaining of the liquid 301 and the solidified product 302 are repeated. On the sixth day, as illustrated in the state (c1) in FIG. 14, the liquid 301 newly adheres by printing operation in addition to the solidified product 302 remaining on the nozzle face 111a of the head 111K.

In the sixth round of the nozzle face cleaning, the first wiping operation is performed as illustrated in the state (c2) in FIG. 14, and the newly adhering liquid 301 and the solidified product 302 accumulating so far are removed from the nozzle face 111a. Thus, the nozzle face 111a is made clean.

In this way, the first wiping operation and the second wiping operation are performed, and the head 111 on which the first wiping operation is performed is sequentially changed.

This configuration is advantageous in shortening the maintenance time and efficiently performing cleaning (maintenance), by wiping, of a plurality of heads, compared with a case where all the heads 111 are cleaned by such a wiping operation (first wiping operation) that can fully remove the liquid from the nozzle faces 111a each time (day in the above example).

In addition, compared with the case where all the heads 111 are cleaned by the wiping operation (first wiping operation) that can fully remove the liquid from the nozzle faces 111a each time (day in the above example), damage to the nozzle faces 111a can be reduced.

Next, the execution timing of the nozzle face cleaning is described.

In the present embodiment, as described above, the nozzle face cleaning is executed basically as the operator inputs the execution of the nozzle face cleaning from a control panel after the printing of the day completes. Alternatively, the nozzle face cleaning is automatically executed in response to power off.

The purpose of the nozzle face cleaning is to remove deposits such as mist adhering to the nozzle face 111a, generated in one day. In a liquid discharge apparatus, mist may adhere to the nozzle face as the liquid is discharged. Especially a printer for mass printing performs printing continuously for several hours to several tens of hours in one day. Accordingly, it is possible that a large amount of mist adheres to the nozzle face or the mist dries on the nozzle face due to long-time printing.

If printing is continued with the mist adhering to the nozzle face, discharge defect may occur, or mist accumulates on the nozzle face one after another and contacts the conveyed sheet, resulting in stain on the sheet and jamming.

Therefore, regular cleaning of the nozzle face is necessary to remove the liquid such as the adhering mist.

In this case, the nozzle face cleaning may be performed during printing, but downtime occurs because printing needs to be stopped during the nozzle face cleaning. During printing, the amount of mist adhering to the nozzle face is small, or drying of the mist is not yet advanced. When executed during printing, the nozzle face cleaning is easier. Accordingly, the wiping pressure and the number of times of wiping can be low, and damage to the nozzle face can be smaller.

However, in the configuration including a plurality of heads, the number of times of cleaning of the nozzle faces is as many as the number of heads. Accordingly, when the nozzle face cleaning is executed during printing, the downtime is long, which is a disadvantage.

Thus, the downtime in the printing can be prevented by executing the nozzle face cleaning not during the printing, but, for example, after the end of the printing of the day. If cleaning to fully remove mist is performed each time, damage to the nozzle face is large because the amount of mist adhering to the nozzle face is large and drying is advanced.

Therefore, as described above, damage to the nozzle face can be minimized in the configuration where the first wiping operation and the second wiping operation can be selectively performed so that the first wiping operation is performed on a part of the heads, and the second wiping operation is performed on the rest of the heads.

Alternatively, the nozzle face cleaning can be automatically executed while the printer 1 starts up, before the start of printing of the day, not after the end of printing of the day. Since the printer 1 includes the drying unit 30 that requires a long start-up time, the nozzle face can be executed within the start-up time of a heater of the drying unit 30. Accordingly, such setting can avoid spending the time of the printer 1 only for the nozzle face cleaning.

However, in the case of executing the nozzle face cleaning during the start-up of the printer 1, drying of the mist adhering to the nozzle face on the previous day advances. Accordingly, it may be difficult to clean the nozzle face in the second wiping operation. Therefore, it is preferable to select either after the end of printing or before the start of printing (during the start-up of the apparatus) considering the characteristics of the liquid used, the durability of the nozzle face, and the like.

Alternatively, the printer 1 can allow a user to execute the nozzle face cleaning at any timing desirable to the user. For example, if the user does not care about downtime, the nozzle face cleaning can be executed at any timing during printing. Alternatively, the user can select one of after the end of the printing of the day and before the start of printing. Conveniences of the user can improve when the cleaning is executable at any timing.

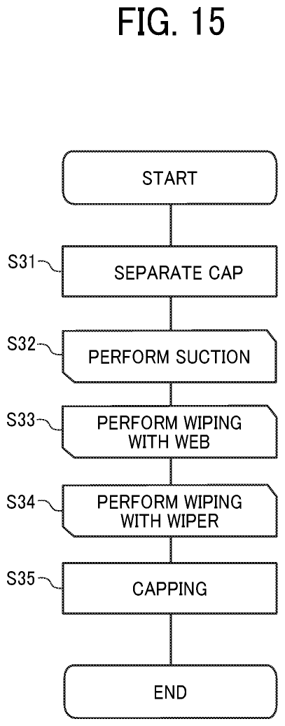

Next, a description is given of the normal cleaning in the nozzle face cleaning (S9 in FIG. 9) with reference to the flowchart in FIG. 15.

When starting the normal cleaning, the wiping controller 501 decaps the heads 111, that is, separates the heads 111 from the suction cap 701 and moisturizing caps 702 (S31).

Thereafter, the wiping controller 501 caps and sucks a suction target head 111 with the suction cap 701, which is referred to as a suction operation (S31). Next, the wiping controller 501 wipes the nozzle face 111a with the web 804 of the wiping unit 800, which is referred to as a web wiping operation (S32). Thereafter, the wiping controller 501 wipes the nozzle face 111a with the wiper 824 of the wiping unit 800, which is referred to as a wiper wiping operation (S34).

Then, the wiping controller 501 caps the nozzle faces 111a of the heads 111 (S35).

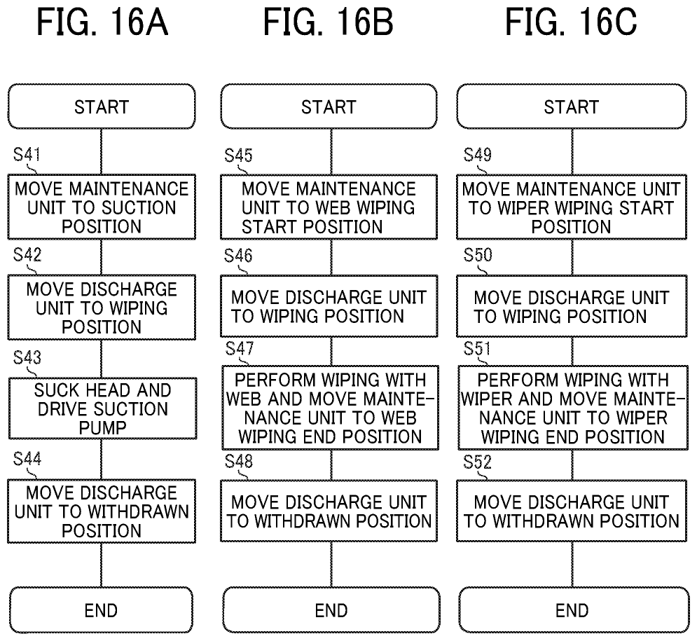

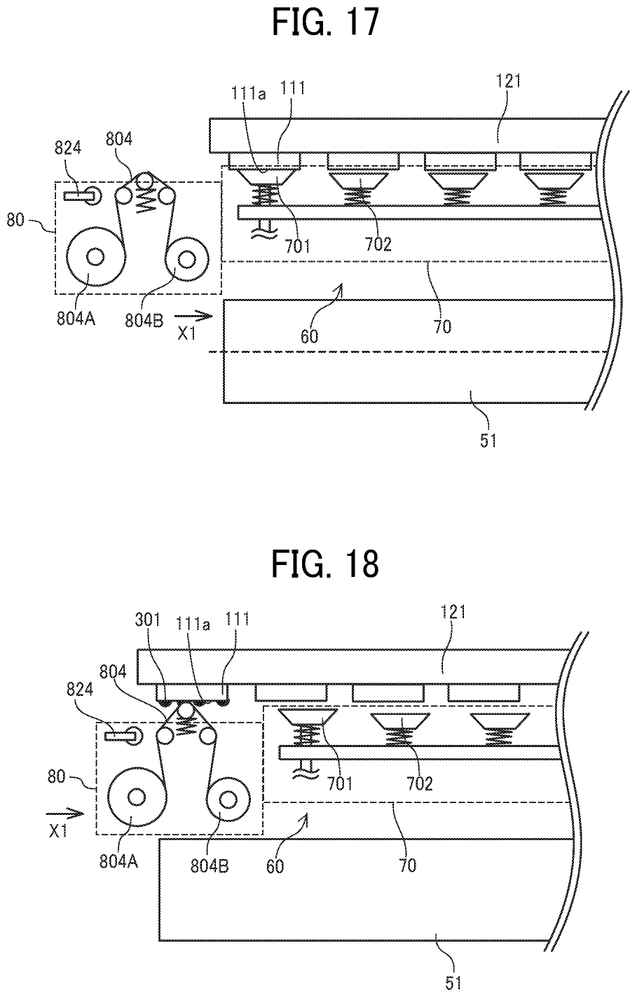

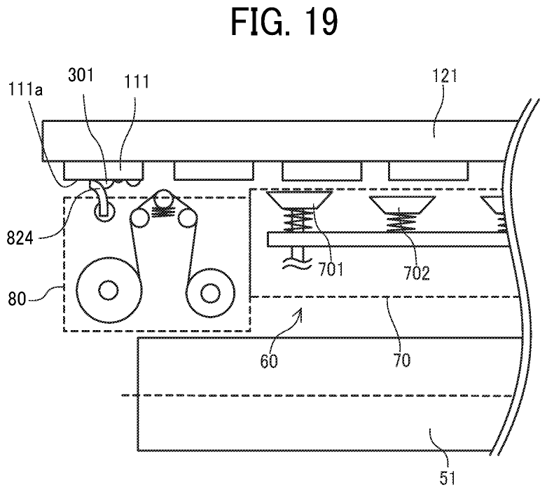

Next, descriptions are given of the suction operation, the web wiping operation, and the wiper wiping operation with reference to FIGS. 16A to 19. FIGS. 16A, 16B, and 16C are flowcharts of the suction operation, the web wiping operation, and the wiper wiping operation, respectively. FIG. 17 is a front view of the maintenance unit 60 performing the suction operation. FIG. 18 is a front view of the maintenance unit 60 the web wiping operation. FIG. 19 is a front view of the maintenance unit 60 performing the wiper wiping operation.

Referring to FIG. 16A and FIG. 17, when the suction operation is started, in S41, the maintenance unit 60 moves to a suction position where the suction cap 701 faces the suction target head 111, which is, for example, the head 111A (see FIG. 4).

Thereafter, the discharge unit 23 descends to the suction position and the head 111 is capped with the suction cap 701 (S42). The suction device provided to the suction cap 701 is driven, and the liquid is discharged from the nozzles 112 of the head 111 into the suction cap 701, which is referred to as head suction, (S43). When the suction device finishes the suction, the discharge unit 23 is raised to the withdrawn position, and the suction operation is finished (S44).

Referring to FIGS. 16B and 18, when the web wiping operation is started, in S45, the maintenance unit 60 moves to the position where the pressing member 809 of the wiping unit 800 reaches the wiping start position of the wiping target head 111, which is, for example, the head 111A (see FIG. 4).

Thereafter, the discharge unit 23 descends to the wiping position, and the nozzle face 111a of the head 111 is pressed against the web 804 (S46). As the maintenance unit 60 moves in this state, the web 804 wipes off the liquid 301 adhering to the nozzle face 111a (S47). When the maintenance unit 60 moves to the wiping end position and the wiping of the nozzle face 111a is finished, the discharge unit 23 rises to the withdrawn position. Then, the suction operation is finished (S48).

At this time, the cleaning liquid application device 840 can apply the cleaning liquid 880 to the web 804. Since the purpose of the normal cleaning is not to remove the dried liquid, the action of re-dispersing the liquid with the cleaning liquid is not essential. However, in the case of a liquid that easily dries, it is possible that the liquid adhering to the nozzle face dries and solidifies in a period from the suction operation to the web wiping operation. Accordingly, application of the cleaning liquid is preferred in some cases. Additionally, the nozzle face is less damaged in wiping with the cleaning liquid applied than dry wiping without application of the cleaning liquid.

With reference to FIG. 16C and FIG. 19, when the wiper wiping operation is started, in S49, the maintenance unit 60 moves to the position where the wiper 824 of the wiping unit 800 reaches the wiping start position of the head 111 to be wiped, which is, for example, the head 111A (see FIG. 4).

Thereafter, the discharge unit 23 descends to the wiping position, and the wiper 824 is pressed against the nozzle face 111a of the head 111 (S50). As the maintenance unit 60 moves in this state, the wiper 824 wipes off the liquid 301 from the nozzle face 111a (S51). When the maintenance unit 60 moves to the wiping end position and the wiping of the nozzle face 111a is finished, the discharge unit 23 rises to the withdrawn position. Then, the suction operation is finished (S52).

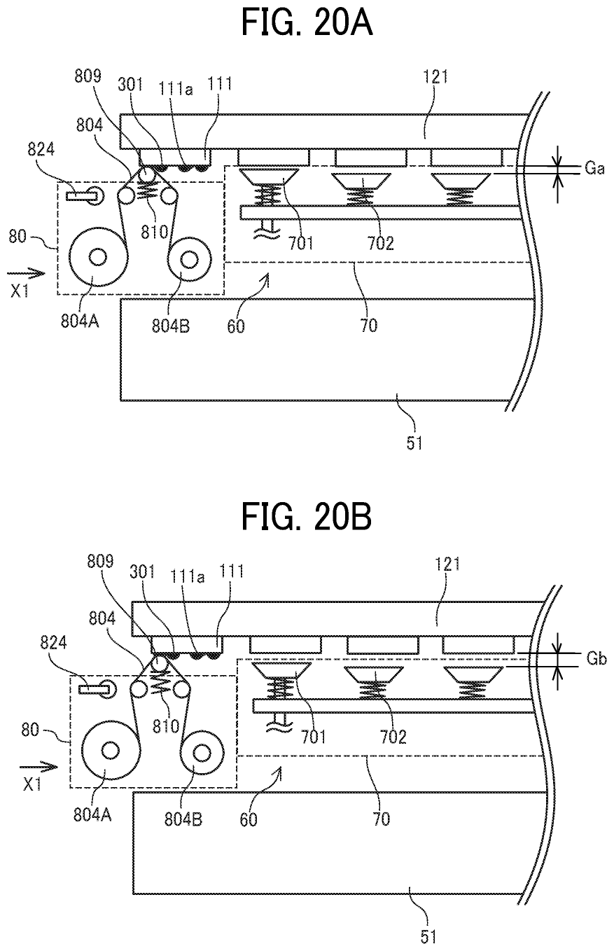

Next, a description is given of first wiping operation and second wiping operation in a second embodiment of the present disclosure, with reference to FIGS. 20A and 20B. FIGS. 20A and 20B are front views of the maintenance unit 60 performing the first wiping operation and the second wiping operation, respectively.

In the present embodiment, the pressing force of the web 804 (the wiping member) against the nozzle face is greater in the first wiping operation illustrated in FIG. 20A than in the second wiping operation illustrated in FIG. 20B.

Specifically, the position to which the discharge unit 23 is lowered is different between the first wiping operation and the second wiping operation. In the first wiping operation illustrated in FIG. 20A, the discharge unit 23 is lowered until the gap between the nozzle face 111a and the suction cap 701 becomes a gap Ga. In the second wiping operation illustrated in FIG. 20B, the discharge unit 23 is lowered until the gap between the nozzle face 111a and the suction cap 701 becomes a gap Gb (Gb>Ga).

That is, in the first wiping operation, the amount by which the discharge unit 23 descends is made larger than that amount in the second wiping operation, thereby increasing the pressing force of the web 804 exerted by the pressing spring 810. Accordingly, the wiping pressure at the time of web wiping can increase.

Changing the wiping pressure of the web 804 is advantageous in limiting increases in time required for wiping as compared with the case where the number of times of wiping is changed as in the first embodiment.

However, as the wiping pressure increases, damage to the nozzle face 111a increases. Therefore, it is preferable to determine the number of times of wiping and the strength of wiping pressure in consideration of damage to the nozzle face 111a.

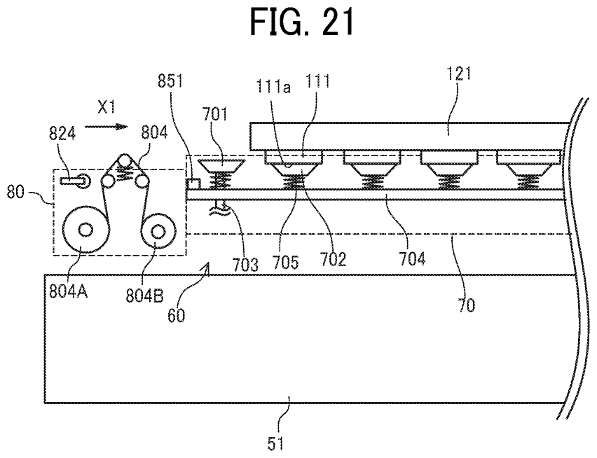

Next, a third embodiment of the present disclosure is described with reference to FIG. 21. FIG. 21 is a front view illustrating a maintenance unit according to the third embodiment.

In the present embodiment, the maintenance unit 60 includes an adhesion state detector 851 (an adhering liquid detector), such as an image sensor, disposed on the cap holder 704. The adhesion state detector 851 detects the states of liquid adhering to the nozzle faces 111a of the heads 111.

Accordingly, while the maintenance unit 60 moves in the wiping direction X1, the state of the deposits adhering to the nozzle face 111a of the wiping target head 111 can be detected prior to wiping by the wiping unit 800.

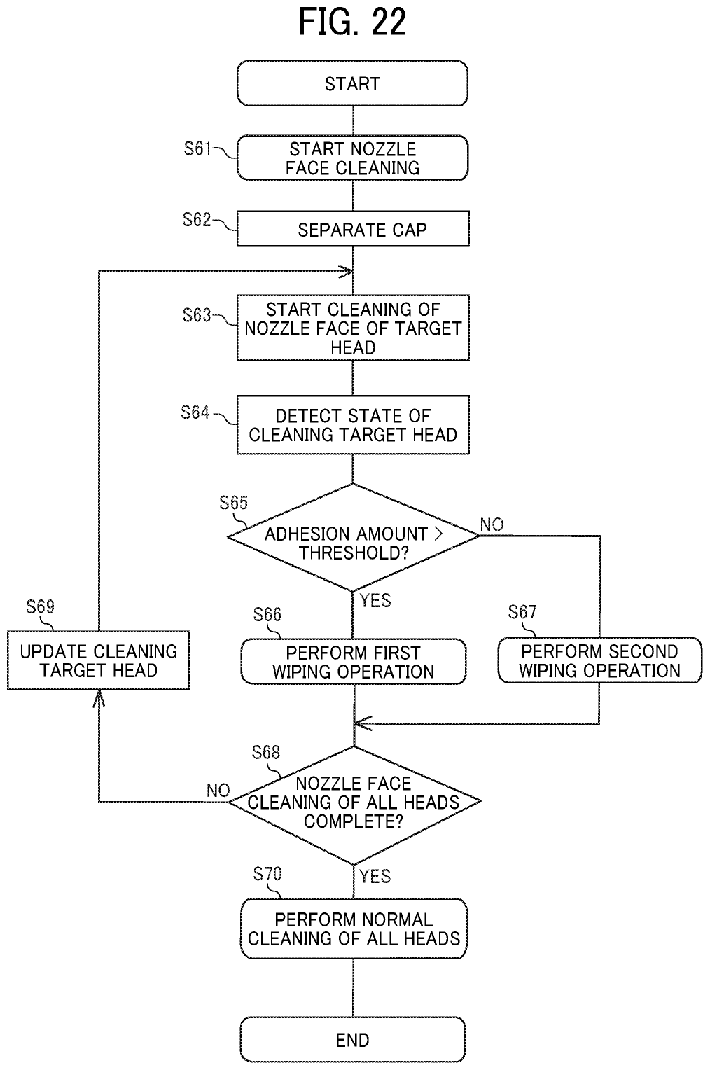

Next, a description is given of the maintenance operation including the wiping operation controlled by the wiping controller according to a third embodiment, with reference to the flowchart of FIG. 22.

In the maintenance operation according to the present embodiment, in steps S61 to S63, cleaning of the cleaning target head 111 is started similar to the maintenance operation in the first embodiment.

At that time, the wiping controller 501 (described in the first embodiment) acquires, from the adhesion state detector 851, the result of detection of the cleaning target head 111, as information relating to the amount of adhesion of liquid or the like on the nozzle face 111a of the head 111 (S64).

Then, the wiping controller 501 determines, from the detection result of the adhesion state, for example, whether or not the adhesion area of the deposits exceeds a threshold and thus determines whether or not the adhesion amount exceeds a threshold (S65).

In response to a determination that the adhesion amount exceeds the threshold, the wiping controller 501 performs the first wiping operation on that head 111 (S66). In response to a determination that the adhesion amount does not exceed the threshold, the wiping controller 501 performs the second wiping operation on that head 111 (S67). Thereafter, the process from S68 to S70 is performed similar to the process from S7 to S10 of the first embodiment.

That is, in the above-described first embodiment, the head cleaned by the first wiping operation is changed in order each time the nozzle face cleaning is executed. In such processing, all the heads are cleaned by the first wiping operation periodically. Conversely, the first wiping operation is not performed unless a certain period elapses.

For example, in a case where a large amount of an identical chart is printed day, depending on the chart, there may be a liquid discharge head that discharges a large amount of liquid and a liquid discharge head that hardly discharges the liquid. The head that discharged a greater amount of liquid produces more mist and the amount of liquid adhering to the nozzle face increases. Accordingly, regarding the condition of the nozzle face after the end of printing of the day, a greater amount of liquid and the like adhere to some heads, and a smaller amount of liquid and the like adhere to other heads.

Thus, in the case where the amount of liquid adhering to the nozzle face differs among the heads, the efficiency may be low if the heads on which the first wiping operation is performed are changed in order. When the first wiping operation on the head having a large amount of adhering liquid is performed only in a fixed cycle, the liquid not removed only by the second wiping operation keeps accumulating. On the other hand, when the first wiping operation on the head having a small amount of adhering liquid is performed in the fixed cycle, there is a risk of excessive damage to the nozzle face.

Therefore, the amount of liquid adhering to the nozzle face 111a of the head 111 is detected. Based on the detection result, the first wiping operation is performed on the head having a large amount of adhesion and significantly contaminated (the amount of adhesion exceeds the threshold), and the second wiping operation is performed on the other heads.

Accordingly, the nozzle face of the head can be more efficiently cleaned, and damage to the nozzle face of the head can be reduced.

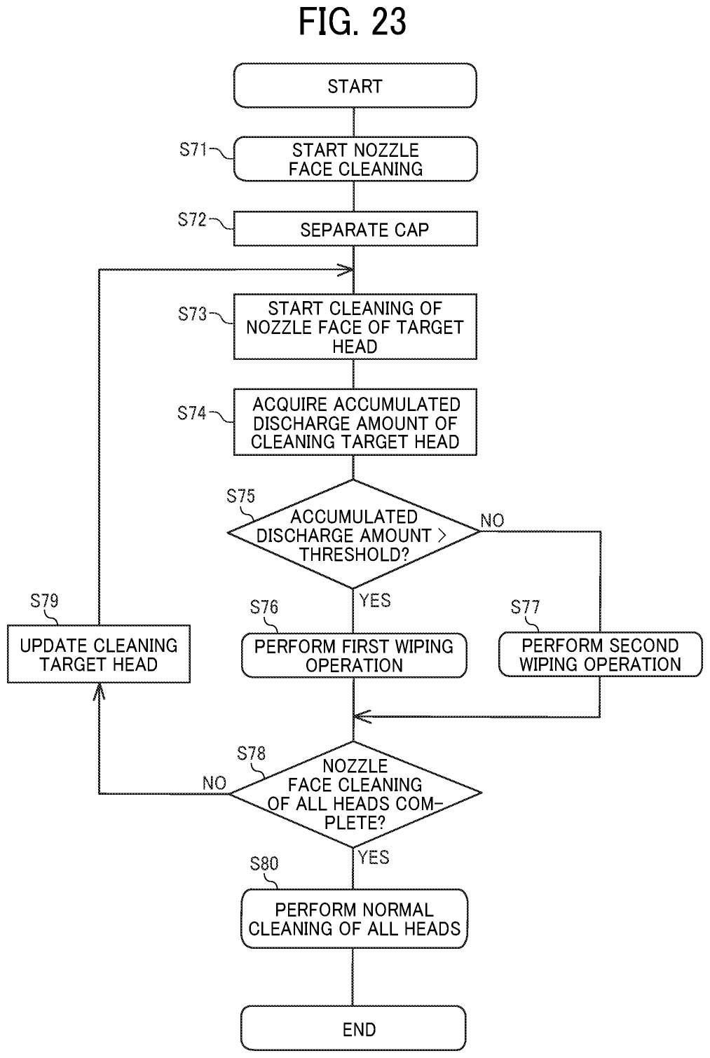

Next, a fourth embodiment of the present disclosure is described with reference to the flowchart in FIG. 23. FIG. 23 is a flowchart illustrating a maintenance operation according to the fourth embodiment, including the wiping operation (nozzle face cleaning) controlled by the wiping controller.

In the present embodiment, each head 111 is provided with a counter to count (measure) a cumulative discharge amount, and the cumulative discharge amount is input to the wiping controller 501 similar to that of the first embodiment. For example, such a counter is implemented by components of the discharge unit drive controller 201. The discharge amount is obtained by multiplying the number of discharged droplets with the volume of droplet.

In the present embodiment, in steps S71 to S73, cleaning of the cleaning target head 111 is started similar to the first embodiment.

The wiping controller 501 described in the first embodiment acquires the cumulative discharge amount (cumulative information) of the cleaning target head 111 as information correlated with the amount of adhesion of the liquid on the nozzle face 111a of the head 111 (S74).

Then, the wiping controller 501 determines whether the acquired cumulative discharge amount exceeds the threshold (S75).

In response to a determination that the cumulative discharge amount exceeds the threshold, the wiping controller 501 performs the first wiping operation on that head 111 (S76). In response to a determination that the cumulative discharge amount does not exceed the threshold, the second wiping operation is performed on that head 111 (S77). Thereafter, the process from S78 to S80 is performed similar to S7 to S10 of the first embodiment.

When the nozzle face cleaning is performed, the count value of the cumulative discharge amount is reset.

In this way, like the above-described third embodiment, the nozzle face of the head can be cleaned more efficiently, and the damage to the nozzle face of the head can be reduced.

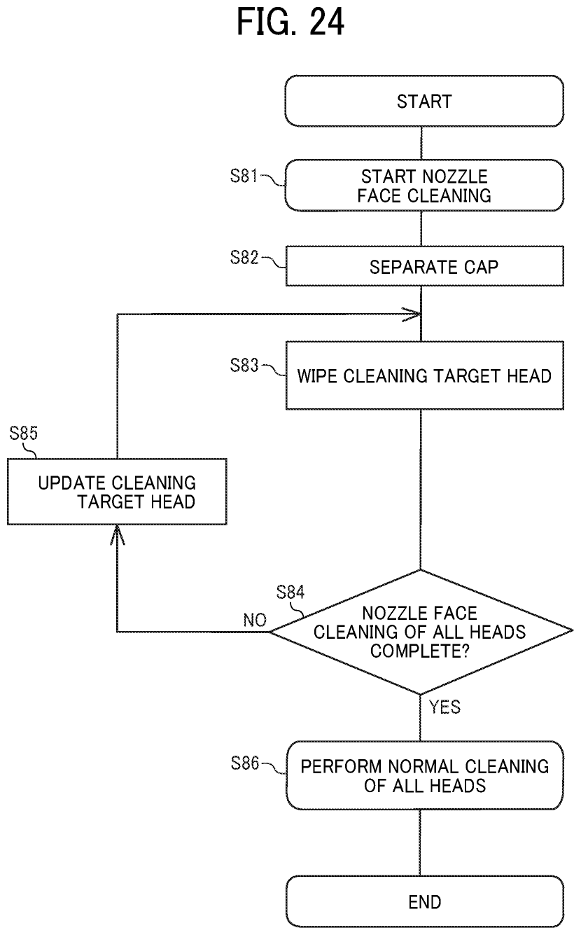

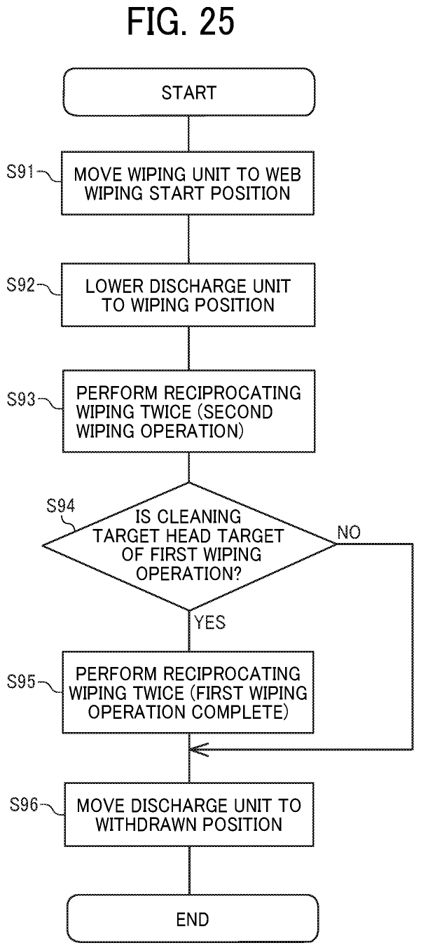

Next, a fifth embodiment of the present disclosure is described with reference to FIGS. 24 and 25. FIG. 24 is a flowchart illustrating a maintenance operation according to the fifth embodiment, including the wiping operation (nozzle face cleaning) controlled by the wiping controller. FIG. 25 is a flowchart of the wiping operation in FIG. 24.

Referring to FIG. 24, similarly to the first embodiment, the wiping controller 501 starts the nozzle face cleaning in which the nozzle faces 111a of the heads 111 are wiped and cleaned by the web 804 (S81) and separates the caps 701 and 702 of the cap unit 70, that is, decaps the nozzle faces 111a (S82).

Thereafter, the wiping controller 501 causes the wiping unit 800 to move to the wiping start position of the cleaning target head 111 (a wiping target) and wipe the nozzle face 111a (S83).

Thereafter, the wiping controller 501 determines whether or not the cleaning (nozzle face cleaning) by wiping of the nozzle faces 111a of all the heads 111 has been completed (S84). In response to the determination that the nozzle face cleaning of all the heads 111 is not yet completed, the wiping controller 501 updates the cleaning target head 111 (S85), and repeats the operations from S83 to S84.

In response to the determination that the nozzle face cleaning of all the heads 111 is completed, the wiping controller 501 performs normal cleaning of all the heads 111 (S86).

Referring to FIG. 25, in the wiping operation performed in S83 in FIG. 24, the wiping controller 501 moves the wiping unit 800 to the wiping start position by the web 804 (S91), and lowers the discharge unit 23 to the wiping position via the discharge unit drive controller 201 (S92).

Then, the wiping controller 501 causes the wiping unit 800 to reciprocate twice in the directions indicated by arrows X1 and X2 and causes the web 804 to wipe the nozzle face 111a (S93). That is, initially the second wiping operation is performed on each head 111.

Then, the wiping controller 501 determines whether or not the cleaning target head 111 is a target of the first wiping operation (S94). As described in the embodiment above, regarding this determination, the target head 111 can be updated day. Alternatively, for example, the target head 111 can be determined based on the amount of adhesion.

When the cleaning target head 111 is the target of the first wiping operation, the wiping controller 501 causes the wiping unit 800 to reciprocate twice in the directions indicated by arrows X1 and X2 and causes the web 804 to wipe the nozzle face 111a of that head 111 (S95). The two reciprocations are added to those in the second wiping operation already performed. Thus, the first wiping operation, in which the number of reciprocating wiping is four, completes.

Thereafter, the wiping controller 501 raises the discharge unit 23 to the withdrawn position via the discharge unit drive controller 201 (S96).

On the other hand, when the cleaning target head 111 is not the target of the first wiping operation, the wiping unit 800 does not perform wiping, and the discharge unit 23 is raised to the withdrawn position (S96).

Thus, when the number of times of wiping is different between the first wiping operation and the second wiping operation, the first wiping operation can include the second wiping operation. In other words, the second wiping operation is a part of the first wiping operation. The differences between the first wiping operation and the second wiping operation can include, for example, not only the number of times of wiping but also the wiping pressure (for example, the wiping pressure in one wiping is higher in the first wiping operation than the second wiping operation).

In the above-described embodiments, the first wiping operation and the second wiping operation are described as examples in which the number of times of wiping and the pressing force (wiping pressure) of the wiping member (e.g., a web, blade, etc.) are different, but the wiping speed can be changed. When the wiping speed is slower, more firmly solidifying deposits can be removed. Thus, the wiping speed of the first wiping operation can be made slower than the wiping speed of the second wiping operation.

Moreover, when a web is used as the wiping member, a web having a rougher surface roughness can remove a more firmly solidifying deposit. Therefore, the wiper can include two types of webs, as wiping members, different in surface roughness. A web higher in surface roughness is used in the first wiping operation, and a web having lower in surface roughness is used in the second wiping operation.

For example, the web 804 may have a rough surface portion higher in surface roughness and a smooth surface portion lower in surface roughness. Furthermore, the rough surface portions can alternate with the smooth surface portions in the web. In this case, the feeding roller 805 feeds the rough surface portion to a predetermined position during the first wiping operation and feeds the smooth surface portion to the predetermined position during the second wiping operation.

In the present disclosure, the “liquid” discharged is not limited to a particular liquid as long as the liquid has a viscosity or surface tension to be discharged from a head (liquid discharge head). However, preferably, the viscosity of the liquid is not greater than 30 mPa·s under ordinary temperature and ordinary pressure or by heating or cooling. Examples of the liquid include a solution, a suspension, or an emulsion including, for example, a solvent, such as water or an organic solvent, a colorant, such as dye or pigment, a functional material, such as a polymerizable compound, a resin, a surfactant, a biocompatible material, such as DNA, amino acid, protein, or calcium, and an edible material, such as a natural colorant. Such a solution, a suspension, or an emulsion can be used for, e.g., inkjet ink, surface treatment liquid, a liquid for forming components of electronic element or light-emitting element or a resist pattern of electronic circuit, or a material solution for three-dimensional fabrication.

A “liquid discharge head” includes those employing, as an energy source to generate energy to discharge liquid, a piezoelectric actuator (a laminated piezoelectric element or a thin-film piezoelectric element), a thermal actuator that employs an electrothermal transducer element, such as a heat element, or an electrostatic actuator including a diaphragm and opposed electrodes.

A “liquid discharge apparatuses” include apparatuses that drive a liquid discharge head to discharge liquid. The liquid discharge apparatus is not limited to an apparatus capable of discharging a liquid to a material to which liquid can adhere but includes an apparatus that discharges a liquid toward gas or into liquid.

The liquid discharge apparatus can include at least one of devices for feeding, conveying, and discharging a material to which liquid can adhere. The liquid discharge apparatus may further include at least one of a pretreatment apparatus and a post-treatment apparatus.

As the liquid discharge apparatuses, for example, there are image forming apparatuses to discharge ink onto sheets to form images and three-dimensional fabricating apparatuses to discharge molding liquid to a powder layer in which powder is molded into a layer-like shape, so as to form three-dimensional fabricated objects.

The “liquid discharge apparatus” is not limited to an apparatus to discharge liquid to visualize meaningful images, such as letters or figures. For example, the liquid discharge apparatus may be an apparatus to form arbitrary images, such as arbitrary patterns, or fabricate three-dimensional images.

The above-mentioned term “material to which liquid can adhere” represents a material which liquid can, at least temporarily, adhere to and solidify thereon, or a material into which liquid permeates. Examples of “material to which liquid can adhere” include paper sheets, recording media such as recording sheet, recording sheets, film, and cloth; electronic components such as electronic substrates and piezoelectric elements; and media such as powder layers, organ models, and testing cells. The term “material to which liquid can adhere” includes any material to which liquid adheres, unless particularly limited.

The above-mentioned “material to which liquid adheres” may be any material, such as paper, thread, fiber, cloth, leather, metal, plastic, glass, wood, ceramics, or the like, as long as liquid can temporarily adhere.

The “liquid discharge apparatus” may be an apparatus in which the liquid discharge head and a material to which liquid can adhere move relatively to each other. However, the liquid discharge apparatus is not limited to such an apparatus. For example, the liquid discharge apparatus can be a serial head apparatus that moves the liquid discharge head or a line head apparatus that does not move the liquid discharge head.

Examples of the “liquid discharge apparatus” further include a treatment liquid coating apparatus to discharge a treatment liquid to a sheet to coat the treatment liquid on a sheet surface to reform the sheet surface and an injection granulation apparatus in which a composition liquid including raw materials dispersed in a solution is discharged through nozzles to granulate fine particles of the raw materials.

The terms “image formation”, “recording”, “printing”, “image printing”, and “fabricating” used herein may be used synonymously with each other.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A liquid discharge apparatus comprising:
a plurality of heads each of which includes a nozzle face having a plurality of nozzles configured to discharge a liquid;
a wiper including a wiping member configured to clean, by wiping, the nozzle face of each of the plurality of heads; and
circuitry configured to:
control cleaning of the plurality of heads by the wiper;
cause the wiper to perform a first wiping operation on a part of the plurality of heads; and
cause the wiper to perform a second wiping operation, different from the first wiping operation, on a rest of the plurality of heads.

2. The liquid discharge apparatus according to claim 1,
wherein the circuitry is configured to change a target of the first wiping operation among the plurality of heads each time performing cleaning of the plurality of heads.

3. The liquid discharge apparatus according to claim 1,
wherein a number of times of wiping in the first wiping operation is greater than a number of times of wiping in the second wiping operation.

4. The liquid discharge apparatus according to claim 1,
wherein a wiping speed in the first wiping operation is slower than a wiping speed in the second wiping operation.

5. The liquid discharge apparatus according to claim 1,
wherein a wiping pressure with which the wiper presses the wiping member against the nozzle face is higher in the first wiping operation than the second wiping operation.

6. The liquid discharge apparatus according to claim 1,
wherein the wiper includes a plurality of wiping members including the wiping member, the plurality of the wiping members including:
a first wiping member; and
a second wiping member lower in surface roughness than the first wiping member, and
wherein the circuitry is configured to cause the wiper to use the first wiping member in the first wiping operation and use the second wiping member in the second wiping operation.

7. The liquid discharge apparatus according to claim 1, further comprising a cleaning liquid application device configured to apply a cleaning liquid to the wiping member,
wherein the circuitry is configured to cause the cleaning liquid application device to apply the cleaning liquid to the wiping member in the first wiping operation and not to apply the cleaning liquid to the wiping member in the second wiping operation.

8. The liquid discharge apparatus according to claim 1,
wherein the circuitry is configured to cause the wiper to perform one of the first wiping operation and the second wiping operation based on information correlated with an amount of the liquid adhering to the nozzle face of each of the plurality of heads.

9. The liquid discharge apparatus according to claim 8, further comprising an adhering liquid detector configured to detect the amount of the liquid adhering to the nozzle face of each of the plurality of heads,
wherein the information correlated with the liquid adhering is information obtained from the adhering liquid detector.

10. The liquid discharge apparatus according to claim 8,
wherein the information correlated with the amount of the liquid adhering is cumulative information representing a cumulative amount of the liquid discharged from each of the plurality of heads.

11. The liquid discharge apparatus according to claim 1,
wherein the circuitry is configured to cause the wiper to perform the second wiping operation as a part of the first wiping operation.
